(19) United States
(12) Patent Application Publication
(10) Pub. No.: US 2021/0096224 A1
(43) Pub. Date: Apr. 1, 2021

(54) LIDAR SYSTEM AND METHOD OF CONTROLLING LIDAR SYSTEM, AND AUTONOMOUS DRIVING SYSTEM INCLUDING LIDAR SYSTEM

(71) Applicant: LG ELECTRONICS INC., Seoul (KR)

(72) Inventor: Jejong LEE, Seoul (KR)

(73) Assignee: LG ELECTRONICS INC., Seoul (KR)

(21) Appl. No.: 16/823,168

(22) Filed: Mar. 18, 2020

(30) Foreign Application Priority Data
Sep. 27, 2019 (KR) 10-2019-0119451

(51) Int. Cl. G01S 7/481; G01S 17/931; G01S 17/42; G01S 7/497; G02B 27/09; B60W 30/08

(52) U.S. Cl. CPC G01S 7/4817; G01S 17/931; B60W 30/08; G01S 7/497; G02B 27/0922; G01S 17/42

(57) ABSTRACT

The lidar system includes a light source array in which a plurality of point light sources is simultaneously turned on to generate a laser beam in a form of a surface light source in a flash mode, and positions of the point light sources that are simultaneously turned on are sequentially shifted to generate a laser beam in a form of a point light source or line light source in a scan mode, a light scanner, and a receiving sensor receiving the laser beam and converting the received laser beam into an electrical signal through activated pixels. According to the lidar system, one or more of an autonomous vehicle, an AI device, and an external device may be linked with an artificial intelligence module, a drone ((Unmanned Aerial Vehicle, UAV), a robot, an AR (Augmented Reality) device, a VR (Virtual Reality) device, a device associated with 5G services, etc.

### BACKGROUND OF THE INVENTION

### Field of the Invention

The present disclosure relates to a light imaging detection and ranging (lidar) system, and more particularly, to a lidar system capable of sensing an obstacle at full distance, and an autonomous driving system including the lidar system.

### Related Art

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can be driven by itself without operation by a driver or a passenger and an autonomous driving system refers to a system that monitors and controls such an autonomous vehicle so that the autonomous vehicle can be driven by itself.

In the autonomous driving system, there is an increasing demand for technologies that provide passengers or pedestrians with safer traveling environment as well as technologies that control the vehicle to quickly travel to a destination. To this end, autonomous vehicles require various sensors to quickly and accurately detect the surrounding terrains and objects in real time.

A lidar (Light Imaging Detection and Ranging) system radiates laser light pulses to an object and analyzes light reflected by the object, thereby being able to sense the size and disposition of the object and to measure the distance from the object.

### SUMMARY OF THE INVENTION

The present disclosure has been made to meet and/or solve the aforementioned needs and/or the problems.

An object of the present disclosure is to provides an autonomous driving system including a lidar system, a controlling the lidar system, and the lidar system that can improve an eye safety problem caused by a high-power laser beam, and improve a constraint problem on a detection distance and an angle of view.

The present disclosure quickly detects obstacles around a vehicle by scanning an object in a flash mode when detecting a near distance or when the vehicle is traveling at a low speed.

The present disclosure improves the signal saturation problem by lowering the gain of the signal processor in the flash mode.

The present disclosure detects the object in the scan mode when the medium/long distance detection or when the speed of the vehicle is faster to detect the object without the eye safety problem and reduces the power consumption of the lidar system.

The problems to be solved in the present disclosure are not limited to the above-mentioned problems, and other problems not mentioned will be clearly understood by those skilled in the art from the following description.

A lidar system according to an embodiment of the present disclosure includes a light source array in which a plurality of point light sources is simultaneously turned on to generate a laser beam in a form of a surface light source in a flash mode, and positions of the point light sources that are simultaneously turned on are sequentially shifted to generate a laser beam in a form of a point light source or line light source in a scan mode, a light scanner moving the laser beam in the form of the point light source or the line light source generated in the scan mode; and a receiving sensor receiving the laser beam and converting the received laser beam into an electrical signal through activated pixels.

A method of controlling a lidar system according to an embodiment of the present disclosure includes, setting a flash mode in which a plurality of point light sources arranged in a light source array is simultaneously turned on to generate a laser beam in a form of a surface light source in the light source array; setting a scan mode in which positions of the point light sources that are simultaneously turned on in the light source array are sequentially shifted to generate a laser beam in a form of a point light source or line light source in the light source array; moving the laser beam in the form of the point light source or the line light source generated in the scan mode by using a light scanner disposed in front of the light source array; and converting the laser beam in the flash mode into an electrical signal through activated pixels of a receiving sensor receiving the laser beam.

### BRIEF DESCRIPTION OF THE DRAWINGS

Accompanying drawings included as a part of the detailed description for helping understand the present disclosure provide embodiments of the present disclosure and are provided to describe technical features of the present disclosure with the detailed description.

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of a user equipment and a 5G network in a 5G communication system.

FIG. 4 shows an example of a basic operation between vehicles using 5G communication.

FIG. 5 is a diagram showing a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a signal flow diagram of an autonomous device according to an embodiment of the present disclosure.

FIG. 9 is a diagram referenced to describe a use scenario of a user according to an embodiment of the present disclosure.

FIG. 10 is a diagram showing an example of V2X communication to which the present disclosure can be applied.

FIG. 11 is a diagram showing a resource allocation method in sidelink in which the V2X is used.

FIG. 12 is a block diagram showing a lidar system according to an embodiment of the present disclosure.

FIG. 13 is a block diagram showing a lidar system according to an embodiment of the present disclosure.

FIG. 14 is a block diagram showing a signal processor in detail.

FIG. 15 is a diagram showing an example of a method for scanning an object by using a light source according to an embodiment of the present disclosure.

FIG. 16 is a diagram showing the light source array and the receiving sensor 106 in detail.

FIG. 17 is a diagram showing the laser beams in the flash mode and in the scan mode.

FIG. 18 is a diagram showing an example of a method of adjusting an angle of view.

FIG. 19 is a diagram showing a flash mode according to an embodiment of the present disclosure.

FIG. 20 is a diagram showing a scan mode according to an embodiment of the present disclosure.

FIG. 21 is a flowchart showing an example of a method for controlling a light source according to an embodiment of the present disclosure.

FIG. 22 is a diagram showing an example in which a laser beam is moved along a scan angle in the scan mode.

FIG. 23 is a diagram showing pixels of the receiving sensor activated for each scan angle in short distance sensing.

FIGS. 24 and 25 are diagrams showing examples of variable sizes of an optical sensor cluster activated according to a sensing distance.

FIG. 26 is a diagram showing an example of a method of controlling a flash mode and a scan mode selected according to a speed of the vehicle.

The accompanying drawings, included as part of the detailed description in order to assist in understanding of the present disclosure, provides embodiments of the present disclosure, and describe technical characteristics of the present disclosure along with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereafter, a device that requires autonomous driving information and/or 5G communication (5th generation mobile communication) that an autonomous vehicle requires are described through a paragraph A to a paragraph G.

A. Example of Block Diagram of UE and 5G Network

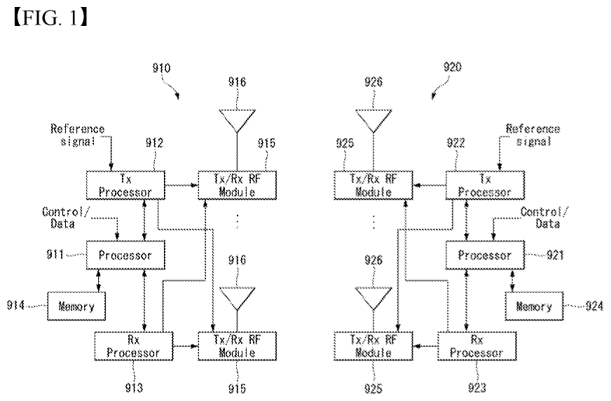

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and ahead mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

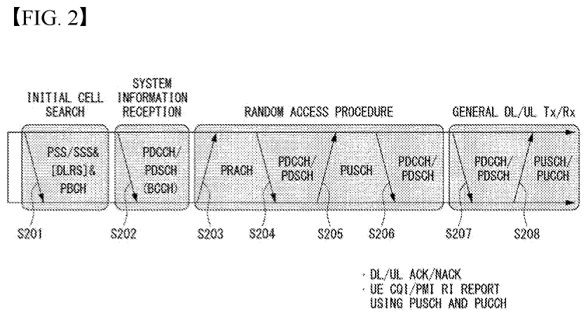

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can beset as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE fora longtime at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

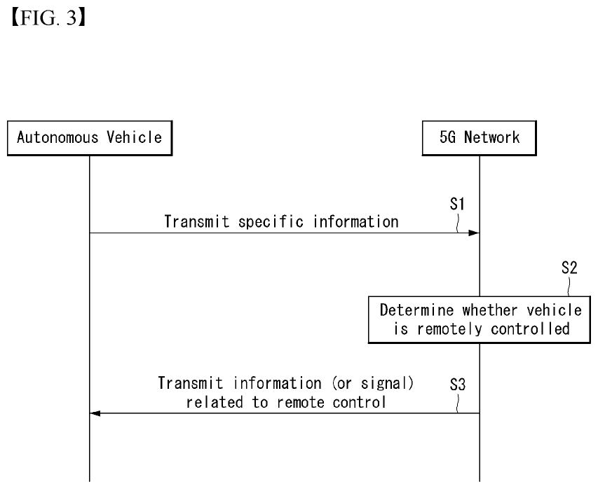

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied operations between autonomous vehicle and 5G network in 5G communication system

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

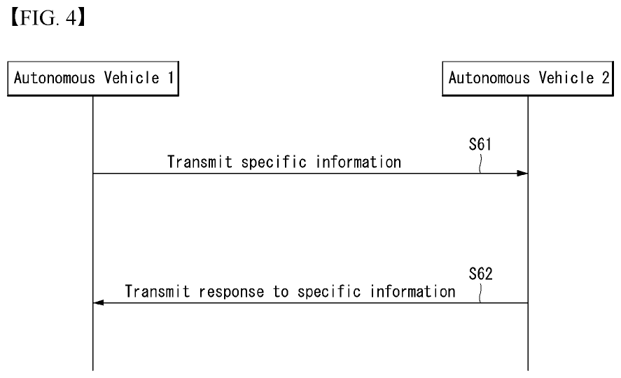

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

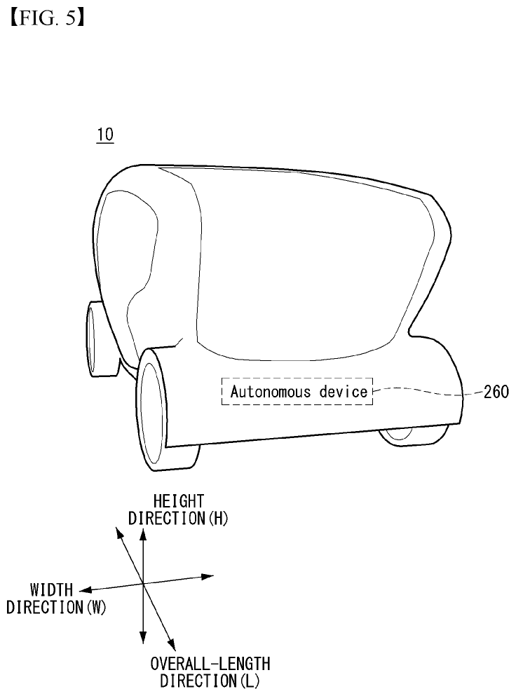

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

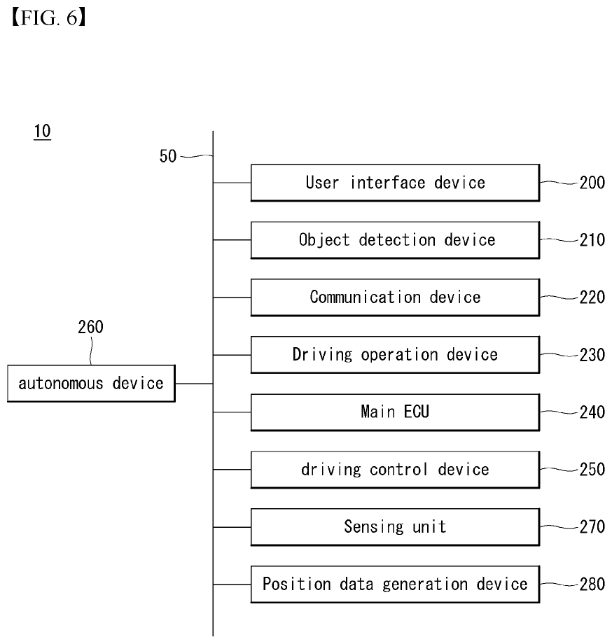

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous driving device 260, a sensing unit 270, and a position data generation device 280. The object detection device 210, the communication device 220, the driving operation device 230, the main ECU 240, the driving control device 250, the autonomous driving device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object overtime. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous driving device 260. For example, the driving control device 250 can control a power train, a steering device and a brake device on the basis of signals received by the autonomous driving device 260.

7) Autonomous Device

The autonomous driving device 260 can generate a route for self-driving on the basis of acquired data. The autonomous driving device 260 can generate a driving plan for traveling along the generated route. The autonomous driving device 260 can generate a signal for controlling movement of the vehicle according to the driving plan. The autonomous driving device 260 can provide the signal to the driving control device 250.

The autonomous driving device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous driving device 260 can perform switching from a self-driving mode to a manual driving mode or switching from the manual driving mode to the self-driving mode. For example, the autonomous driving device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

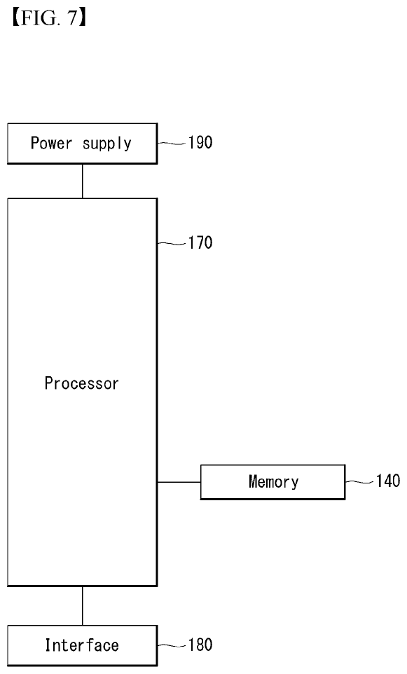

FIG. 7 is a control block diagram of the autonomous device according to an embodiment of the present disclosure.

Referring to FIG. 7, the autonomous driving device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous driving device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous driving device 260. The power supply 190 can be provided with power from a power source (e.g., a battery) included in the vehicle 10 and supply the power to each unit of the autonomous driving device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous driving device 260 may include at least one printed circuit board (PCB). The memory 140, the interface 180, the power supply 190 and the processor 170 may be electrically connected to the PCB.

(4) Operation of Autonomous Device

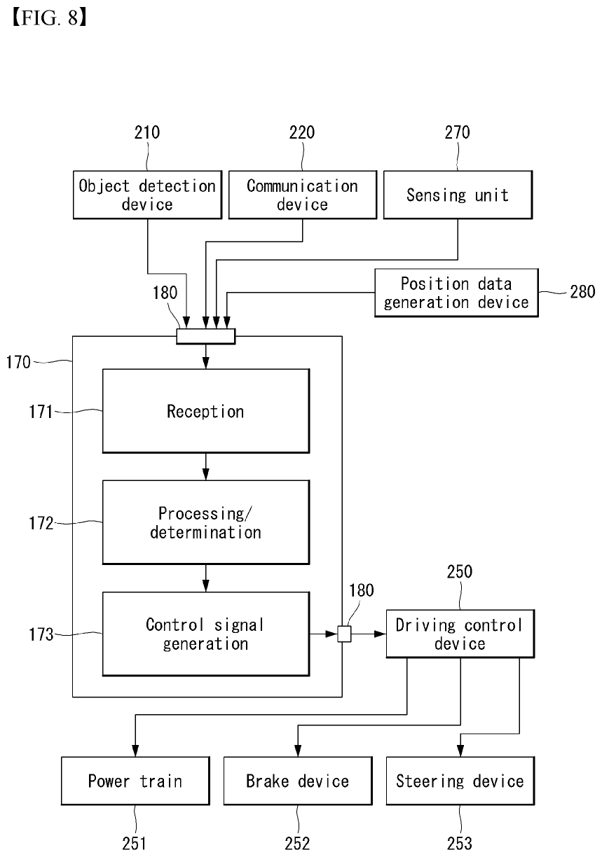

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

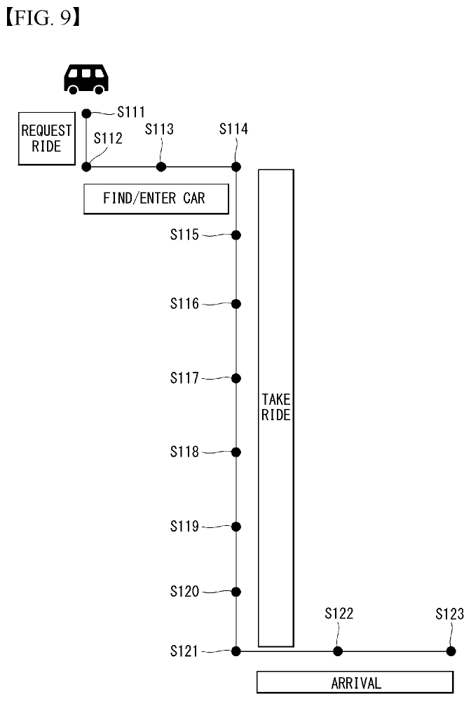

FIG. 9 is a diagram referenced to describe a use scenario of a user according to an embodiment of the present disclosure.

1) Destination Prediction Scenario

The autonomous vehicle may include a cabin system. Hereinafter, the cabin system can be interpreted as a traveling vehicle. A first scenario S111 is a destination prediction scenario of a user. A user terminal may install an application interoperable with the cabin system. The user terminal may predict the destination of the user based on user's contextual information using the application. The user terminal may provide vacancy information in the cabin using the application.

2) Cabin Interior Layout Preparation Scenario

A second scenario S112 is a cabin interior layout preparation scenario. The cabin system may further include a scanning device for acquiring data about a user located outside the vehicle. The scanning device may acquire user's body data and baggage data by scanning the user. The user's body data and the baggage data can be used to set the layout. The user's body data may be used to authenticate the user. The scanning device may include at least one image sensor. The image sensor may acquire a user image using light in a visible light band or an infrared band.

The cabin system may include a seat system. The seat system may set the layout in the cabin based on at least one of the user's body data and the baggage data. For example, the seat system may be provided with a luggage storage space or a car seat installation space.

3) User Welcome Scenario

3) User Welcome Scenario: A third scenario S113 is a user welcome scenario. The cabin system may further include at least one guide light. The guide light may be disposed on a floor in the cabin. The cabin system may output a guide light to allow the user to sit on a predetermined seat among a plurality of seats when the user's boarding is detected. For example, a main controller of the cabin system may implement moving lights by sequentially turning on a plurality of light sources with time from an open door to a predetermined user seat.

4) Seat Adjustment Service Scenario

A fourth scenario S114 is a seat adjustment service scenario. The seat system may adjust at least one element of the seats that match the user based on the acquired body information.

5) Personal Content Providing Scenario

A fifth scenario S115 is a personal content providing scenario. A display system of the cabin system may receive user personal data via an input device or a communication device. The display system may provide content corresponding to the user personal data.

6) Product Providing Scenario

A sixth scenario S116 is a product providing scenario. The cabin system may further include a cargo system. The cargo system may receive user data via the input device or the communication device. The user data may include user's preference data, user's destination data, and the like. The cargo system may provide products based on the user data.

7) Payment Scenario

A seventh scenario S117 is a payment scenario. The cabin system may further include a payment system. The payment system may receive data for price calculation from at least one of the input device, the communication device, and the cargo system. The payment system may calculate a vehicle usage price of the user based on the received data. The payment system may request a payment from a user (for example, a user's mobile terminal) at a calculated price.

8) Display System Control Scenario of User

An eighth scenario S118 is a display system control scenario of a user. The input device of the cabin system may receive a user input of at least one type and convert the user input into an electrical signal. The display system may control the displayed content based on the electrical signal.

9) AI Agent Scenario

A main controller of the cabin system may include an artificial intelligence agent. The artificial intelligence agent may perform machine learning based on data acquired through the input device. The AI agent may control at least one of the display system, the cargo system, the seat system, and the payment system based on the machine-learned result.

A ninth scenario S119 is a multi-channel artificial intelligence (AI) agent scenario for a plurality of users. The artificial intelligence agent may classify user input for each of a plurality of users. The artificial intelligence agent may control at least one of the display system, the cargo system, the seat system, and the payment system based on the electrical signal into which the plurality of user individual user inputs are converted.

10) Multimedia Content Providing Scenario for a Plurality of Users

A tenth scenario S120 is a multimedia content providing scenario for a plurality of users. The display system may provide content that all users can watch together. In this case, the display system may provide the same sound to a plurality of users individually through speakers provided for each sheet. The display system may provide content that a plurality of users can watch individually. In this case, the display system may provide individual sound to a plurality of users through speakers provided for each sheet.

11) User Safety Ensuring Scenario

An eleventh scenario S121 is a user safety ensuring scenario. When acquiring object information around a vehicle that threatens a user, the main controller may control an alarm for an object around the vehicle to be output through the display system.

12) Scenario for Preventing Belonging from Being Lost

A twelfth scenario S122 is a scenario for preventing belongings of a user from being lost. The main controller may acquire data about the belongings of the user through the input device. The main controller may acquire motion data of the user through the input device. The main controller may determine whether the user leaves the belongings and gets off based on the data and the motion data about the belongings. The main controller may control an alarm for the belongings to be output through the display system.

13) Get Off Report Scenario

A thirteenth scenario S123 is a get off report scenario. The main controller may receive get off data of the user through the input device. After the user gets off, the main controller may provide a report data according to getting off to a user's mobile terminal through the communication device. The report data may include total usage fee data of a vehicle 10.

V2X (Vehicle-to-Everything)

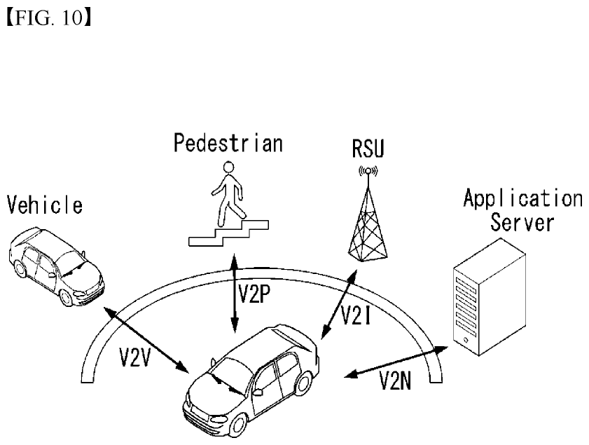

FIG. 10 is a diagram showing an example of V2X communication to which the present disclosure can be applied.

The V2X communication refers to communication between vehicles and all entities such as vehicle-to-vehicle (V2V) which refers to communication between vehicles, vehicle to infrastructure which refers to communication between a vehicle and an eNB or a road side unit (RSU), vehicle-to-pedestrian (V2P) which refers to the communication between a vehicle and UEs carried by an individual (pedestrian, cyclist, vehicle driver, or passenger), and vehicle-to-network (V2N).

The V2X communication may have the same meaning as V2X sidelink or NR V2X or may have a broader meaning including the V2X sidelink or the NR V2X.

The V2X communication can be applied to various services such as forward collision warnings, automatic parking systems, cooperative adaptive cruise control (CACC), control loss warnings, traffic matrix warnings, traffic vulnerable safety warnings, emergency vehicle warnings, speed warning when traveling on curved roads, and traffic flow control.

The V2X communication may be provided via a PC5 interface and/or a Uu interface. In this case, in a wireless communication system supporting V2X communication, specific network entities may exist for supporting communication between the vehicle and all the entities. For example, the network entity may be a BS (eNB), a road side unit (RSU), a UE, an application server (for example, a traffic safety server), or the like.

In addition, the UE performing the V2X communication may mean not only a general handheld UE, but also a vehicle UE (vehicle UE (V-UE)), a pedestrian UE, a BS type (eNB type) RSU, or a UE type RSU, a robot including a communication module, or the like.

The V2X communication may be performed directly between the UEs or via the network entity(s). The V2X operation mode may be classified according to the method for performing V2X communication.

The V2X communication requires support of anonymity and privacy of the UE in the use of the V2X application so that operators or third parties cannot track a UE identifier within an area in which the V2X is supported.

Terms frequently used in V2X communication are defined as follows.
Road side unit (RSU): RSU is a V2X serviceable device that can perform transmission/reception to/from a mobile vehicle using V2I service. In addition, the RSU is a fixed infrastructure entity that supports V2X applications and can exchange messages with other entities that support V2X applications. The RSU is a term frequently used in the existing ITS specification, and the reason for introducing the term in the 3GPP specification is to make the document easier to read in the ITS industry. The RSU is a logical entity that combines V2X application logic with the functionality of a BS (called a BS-type RSU) or a UE (called a UE-type RSU).
V2I service: A type of V2X service in which one is a vehicle and the other is an infrastructure.
V2P service: A type of V2X service in which one is a vehicle and the other is a device carried by an individual (for example, a portable UE device carried by a pedestrian, a cyclist, a driver or a passenger).
V2X service: A 3GPP communication service type associated with transmitting or receiving devices in a vehicle.
V2X enabled UE: UE supporting V2X service.
V2V service: A type of V2X service, in which both communicating objects are vehicles.
V2V communication range: Direct communication range between two vehicles participating in the V2V service.

As described above, the V2X application called vehicle-to-everything (V2X) are four types of (1) vehicle-to-vehicle (V2V), (2) vehicle-to-infrastructure (V2I), (3) vehicle-to-network (V2N), and (4) vehicle-to-pedestrian (V2P).

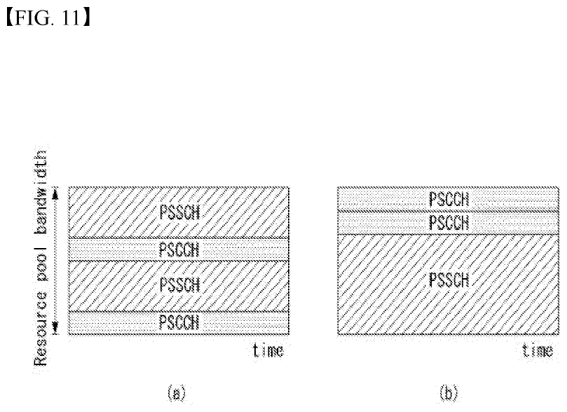

FIG. 11 is a diagram showing a resource allocation method in sidelink in which the V2X is used.

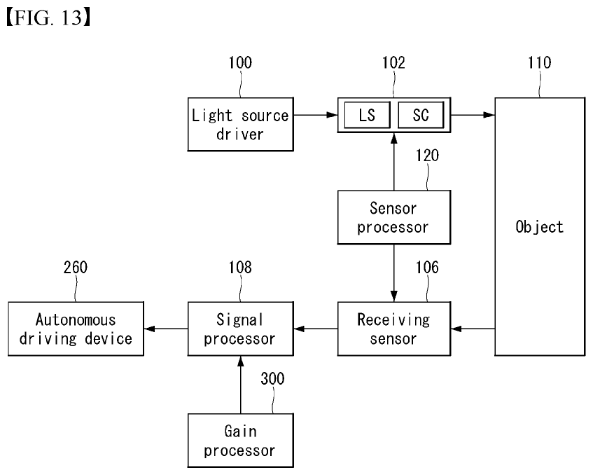

In the sidelink, as shown in FIG. 13A, different physical sidelink control channels (PSCCHs) may be spaced from each other and allocated in the frequency domain, and different physical sidelink shared channels (PSSCHs) may be spaced apart from each other and allocated. Alternatively, as shown in FIG. 13B, different PSCCHs may be continuously allocated in the frequency domain, and the PSSCHs may also be continuously allocated in the frequency domain.

NR V2X

The support for V2V and V2X services in LTE is introduced to extend the 3GPP platform to the automotive industry during 3GPP releases 14 and 15.

Requirements for supporting the enhanced V2X use case are largely grouped into four use case groups.

(1) Vehicle Plating allows vehicles may dynamically form a platoon in which vehicles move together. All the vehicles in the platoon obtain information from a leading vehicle to manage the platoon. This information enables vehicles to drive more harmoniously than normal, go in the same direction and drive together.

(2) Extended sensors may exchange raw or processed data, which are collected via local sensors or live video images, in vehicles, road site units, pedestrian devices, and V2X application servers. Vehicles can increase their environmental awareness more than their sensors can detect. High data rate is one of the main features.

(3) Advanced driving enables semi-automatic or fully-automatic driving. Each vehicle and/or RSU may share its own awareness data obtained from the local sensors with proximity vehicles, and synchronize and coordinate trajectory or maneuver. Each vehicle shares a proximity driving vehicle and a driving intent.

(4) Remote driving enables a remote driver or a V2X application to drive a remote vehicle for passengers who are unable to travel on their own or in a remote vehicle in a hazardous environment. If fluctuations are limited and a route can be predicted as in public transportation, driving based on cloud computing may be used. High reliability and low latency are key requirements.

The 5G communication technology described above may be applied in combination with the methods proposed in the present disclosure to be described later, or may be supplemented to specify or clarify the technical features of the methods proposed in the present disclosure.

Hereinafter, the lidar system according to the embodiment of the present disclosure and an autonomous driving system using the same will be described in detail. In the lidar system according to the present disclosure, at least one of an autonomous vehicle, an AI device, and an external device may be linked with an artificial intelligence module, a drone (unmanned aerial vehicle (UAV)), a robot, an augmented reality (AR) device, a virtual reality (VR) device, devices related to 5G network, and the like. In the following, an embodiment is described based on an example where the lidar system is applied to an autonomous vehicle, but it should be noted that the present disclosure is not limited thereto.

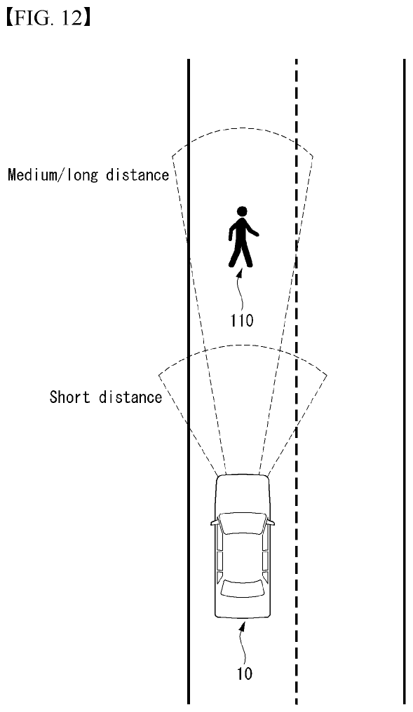

The object detection device 210 may include a lidar system shown in FIGS. 12 to 26.

FIG. 12 is a diagram showing a sensing distance of a lidar system according to an embodiment of the present disclosure.

As shown in FIG. 12, the autonomous vehicle 10 may change a traveling method by recognizing a road or an object 110 around the vehicle while traveling. Specifically, when there is a person on the road, the autonomous vehicle 10 may sense the person to avoid the person or stop traveling.

The autonomous vehicle 10 may use a lidar system to sense an object, and the lidar system may use a vertical cavity surface emitting laser (hereinafter, referred to as “VCSEL”) as a light source. The VCSEL includes a light source array in which a plurality of point light sources is arranged in an array form. Since the plurality of point light sources simultaneously each generates a laser beam, the VCSEL may emit a high power laser beam with a large beam width. The VCSEL generates a high power laser beam with a large beam width for a flash lidar, which is similar to a camera, and the generated laser beam is reflected from an object and incident on a receiving sensor.

Since the VCSEL emits a high power laser beam with a large beam width, there may be eye-safety issues such as human retinal damage. For this reason, when using the VCSEL as a light source of the lidar system, there is a limit on the sensing distance and the angle of view, since the appropriate eye-safety level should be considered.

The present disclosure uses variable clustering of the VCSEL to vary the number of the light sources to be turned on and angles of view so that there is no influence on the human retina according to the sensing distance, the speed of the vehicle, and the traveling environment.

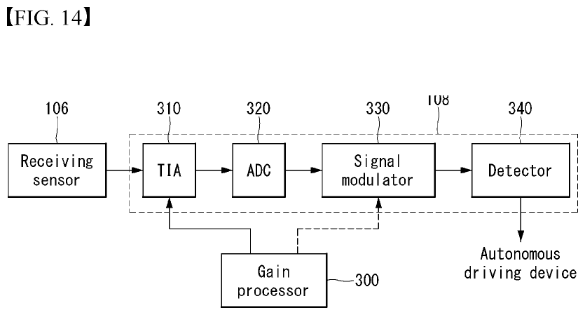

FIG. 13 is a block diagram showing a lidar system according to an embodiment of the present disclosure. FIG. 14 is a block diagram showing a signal processor in detail.

Referring to FIGS. 13 and 14, the autonomous vehicle of the lidar system includes a light source driver 100, a light emitter 102, a receiving sensor 106, a sensor signal processor 108, a gain processor 300, a sensor processor 120, and the like.

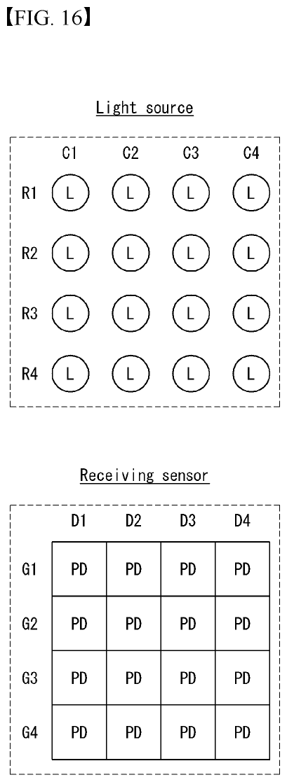

The light emitter 102 may include a light source array LS and a light scanner SC. The light source array LS includes a plurality of point light sources as shown in FIG. 16.

The light source driver 100 supplies a current to the light source array LS to drive the light source array LS. The light source driver 100 may individually drive the point light sources of the light source array LS or may drive the point light sources by variable clustering. Hereinafter, the light source cluster refers to a light source group in which two or more point light sources are simultaneously turned on. Here, the point light sources, which are simultaneously turned on, may be arranged adjacent to each other, or may be spaced apart with a non-light source therebetween. “Variable clustering” means that the number of point light sources that are simultaneously turned on is variable, or the size of the light source cluster is variable.

The wavelength of the laser beam generated from the light source array LS may be 905 nm or 1550 nm. The 905 nm laser light source may be implemented as an InGaAs/GaAs-based semiconductor diode laser, and may emit high power laser light. The peak power of the InGaAs/GaAs-based semiconductor diode laser is 25 W in one emitter. In order to increase the output of the InGaAs/GaAs-based semiconductor diode laser, three emitters may be combined into a stack structure to output 75 W of laser light. The InGaAs/GaAs-based semiconductor diode laser may be implemented in a small size and at low cost. The driving mode of the InGaAs/GaAs-based semiconductor diode laser is a spatial mode and a multi mode.

The 1550 nm laser light source may be implemented as a fiber laser, a diode pumped solid state (DPSS) laser, a semiconductor diode laser, or the like. A representative example of the fiber laser is an erbium-doped fiber laser. The 1550 nm fiber laser may emit the 1550 nm laser through the erbium-doped fiber by using the 980 nm diode laser as a pump laser. The peak power of the 1550 nm fiber laser may be up to several kW. The operating mode of the 1550 nm fiber laser is a spatial mode and a few mode. The 1550 nm fiber laser has good light quality and a small aperture size, thereby detecting an object with high resolution. The DPSS laser may emit 1534 nm laser light through laser crystal such as MgAlO or YVO by using the 980 nm diode laser as a pump laser. The 1550 nm semiconductor diode laser may be implemented as an InGaAsP/InP-based semiconductor diode laser, and have a peak power of several tens of Watts. The 1550 nm semiconductor diode laser is smaller than a fiber laser in size.

Laser light may have a different effect on the human retinal damage according to wavelength. For example, 1550 nm laser light is less harmful to the human eye than 905 nm laser light. When the output power of the 1550 nm laser light source is 106 times higher than the output power of the 905 nm laser light source, the eye safety level is equal or higher. Therefore, even if the power of the 1550 nm laser light source is much higher than that of the 905 nm laser light source, it is less harmful to the human eye. Inconsideration of the above, it is preferable to use a 1550 nm laser light source in medium/long distance sensing.

The light source array LS may emit a laser beam in the form of a point light source when the point light sources are individually driven, and may emit the laser beam in the form of a linear light source or a surface light source according to the cluster form. The beam width and beam power of the laser beam may vary according to the cluster size. For example, as the cluster size increases, the number of point light sources to be turned on increases, thereby increasing the beam width of the laser beam and the power of the laser beam.

The light source driver 102 may vary the light power by adjusting the driving current of the light source array LS according to the traveling environment information on the traveling path received through the network. The traveling environment information may include geographic information of a traveling section, traffic congestion information, weather, and the like.

For example, the light source driver 102 may quickly scan a short-distance object by reducing the power of the light source array LS and increasing the size of the light source cluster in a heavy-traffic and crowded urban area. In addition, the light source driver 102 may increase the sensing distance by increasing the power of the light source array LS in a rural area or a plain area with low traffic volume.

The lidar system of the present disclosure may be driven in a flash mode and a scan mode that may be selected according to a sensing distance, a vehicle speed, traveling environment information, and the like.

In the flash mode, the size of the light source cluster is larger than a predetermined size in the vertical and horizontal directions, so that the light source array LS emits a laser beam in the form of a surface light source. In the flash mode, the light source cluster may be set to a maximum size, but is not limited thereto. At the maximum size of the light source cluster, all the point light sources of the light source array LS are simultaneously turned on, so that the beam width and light power of the laser beam are increased and the angle of view is increased.

In the scan mode, the light source array LS is turned on as a point light source or a linear light source in at least one of the vertical and horizontal directions, and the light source which is turned on in the preset scan direction is shifted. In the scan mode, the size of the cluster or the number of point light sources that are simultaneously turned on is set to be smaller or less than that of the flash mode.

The flash mode and scan mode may be set according to the sensing distance of the lidar system and the vehicle speed. The flash mode may be set to a short range (for example, a distance within 50 m) detection mode or when the vehicle travels at a low speed, to a detection mode. The short distance may be within 50 m from the lidar system. The scan mode may be set to a medium/long range detection mode or when the vehicle travels at a high speed, to a detection mode. The medium/long distance may be longer than 50 m.

The lidar system may emit a laser beam in the flash mode to sense the object 110 immediately after the vehicle 10 starts to travel, and may emit the laser beam in the scan mode to sense the object 110 when the speed of the vehicle 10 is a predetermined speed (for example, 50 km/h) or more. Since changing to the medium/long range mode is possible, the scan mode may be changed from the medium/long range mode to the flash mode when the vehicle speed becomes lower than a predetermined speed.

The sensor processor 120 synchronizes the pixels of the receiving sensor 106 and the light scanner SC with each other. The sensor processor 120 may select pixels activated by being synchronized with the laser beam moved by the light scanner SC in the scan mode.

The sensor processor 120 may select only pixels where a main lobe of the laser beam is received by being synchronized with the laser beam moved by the light scanner SC in the scan mode. Only the pixels selected by the sensor processor 120 may be activated, and other pixels may be deactivated.

The sensor processor 120 synchronizes the pixels of the receiving sensor 102 and the scanning of the light scanner SC with each other to selectively activate the pixels according to the scan angle of the laser beam, so that noise increase and malfunction of the received signal due to side lobes of the laser beam may be prevented.

The laser beam generated from the light source array LS is incident on the light scanner SC. The light scanner SC reciprocates the laser beam from the light source array LS to implement a preset angle of view (AOV). The light scanner SC may be implemented as a two-dimensional (2D) scanner for reciprocating the laser beam within a predetermined rotation angle range in each of the horizontal direction (x axis) and the vertical direction (y axis), or two one-dimensional (1D) scanners pivoting in a direction orthogonal to each other. The scanner may be implemented as a galvano scanner or a micro electro mechanical systems (MEMS) scanner.

The laser beam emitted from the light emitter 102 is reflected on the object 110 and received by the receiving sensor 106.

The receiving sensor 106 may include pixels arranged in a matrix type as shown in FIG. 16. The pixels convert the received light into an electrical signal by using a photo-diode.

The signal processor 108 converts the output of the receiving sensor 106 into a voltage and amplifies the voltage, and then converts the amplified signal into a digital signal by using an analog to digital converter (ADC). The signal processor 108 analyzes digital data input from the ADC by using a time of flight (TOF) algorithm or a phase-shift algorithm to sense a distance from the object 110, a shape of the object 110, and the like.

The signal processor 108 includes a trans impedance amplifier (TIA) 310 that converts a current input from the receiving sensor 106 into a voltage and amplifies the voltage, an ADC 320 that converts the output signal of the trans impedance amplifier 310 into a digital signal, a signal modulator 330 that modulates the digital signal output from the ADC 320 with a predetermined gain, a detector 340 that analyzes the output data of the signal modulator 330 by using a TOF or phase shift algorithm to sense a distance and a shape from and of the object 110, a gain processor 300 that controls one or more gains of the trans impedance amplifier 310 and the signal modulator 330, and the like.

The trans impedance amplifier 310 may include multiple amplifiers having different gains. The trans impedance amplifier 310 amplifies the output of the receiving sensor 106 with the gain selected by the gain processor 300. The gain of the trans impedance amplifier 310 may be variable to a programmable gain. In this case, the gain of the trans impedance amplifier 310 may be changed according to a value input from any one of the gain processor 300, the autonomous driving device 260, and an external device connected to the network through I2C communication.

The signal modulator 330 may modulate a digital signal output from the ADC 320, that is, the optical sensor data, by adding a gain value received from the gain processor 300 to the optical sensor data or multiplying the optical sensor data by the gain value.

Any one of the trans impedance amplifier 310 and the signal modulator 330 may be omitted. For example, when various use cases are satisfied by only the gain adjustment of the trans impedance amplifier 310 and the short distance sensing and the medium/long distance sensing performance are sufficient, the signal modulator 330 may be omitted.

The gain processor 300 may vary one or more gains of the trans impedance amplifier 310 and the signal modulator 330 according to the sensing distance. In addition, the gain processor 300 may adjust one or more gains of the trans impedance amplifier 310 and the signal modulator 330 according to the speed of the vehicle 10 and the traveling environment.

The gain processor 300 may receive speed information of the vehicle and road surface state information through the main ECU 240 or a network. The gain processor 300 may receive traveling environment information through a network. The traveling environment information may include geographic information of a traveling section, traffic congestion information, weather, and the like. The gain processor 300 may adjust one or more gains of the trans impedance amplifier 310 and the signal modulator 330 based on one or more of the speed of the vehicle, the road surface state of the road on which the vehicle travels, and the traveling environment information.

The gain processor 300 may vary one or more gains of the trans impedance amplifier 310 and the signal modulator 330 according to the mounting position of the lidar system in the vehicle.

In the flash mode, the power of the laser beam received by the receiving sensor 106 is large and the reflectance of the object at the short distance is high. As a result, in the flash mode, saturation of the signal received by the receiving sensor 106 may occur. In order to offset the signal saturation problem in the flash mode, the gain processor 300 may make the gain of the signal processor 108 in the flash mode smaller than that in the scan mode.

The signal processor 108 may provide sensor data including the distance from the object and the shape information to the autonomous driving device 260. The autonomous driving device 260 receives the sensor data from the lidar system and reflects the information on the detected object in controlling movement of the vehicle.

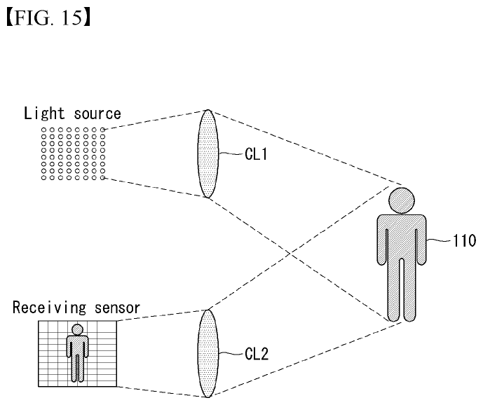

FIG. 15 is a diagram showing an example of a method for scanning an object by using a light source according to an embodiment of the present disclosure.

Referring to FIG. 15, the object 110 is irradiated with the laser beam generated by the light source array LS through a first lens CL1, and the laser beam reflected from the object 110 is received by the receiving sensor 106 through a second lens CL2.

FIG. 16 is a diagram showing the light source array LS and the receiving sensor 106 in detail.

Referring to FIG. 16, the light source array LS includes multiple point light sources L arranged in a matrix form made up of a plurality of row lines R1 to R4 and a plurality of column lines C1 to C4.

In the flash mode, all the point light sources L may be simultaneously turned on to generate a laser beam in the form of a surface light source. In the flash mode, all the point light sources L may not be simultaneously turned on, but the point light sources L of the cluster set to a large size may be simultaneously turned on.

In the scan mode, the point light sources L may be sequentially turned on in a preset scan direction. In the scan mode, the point light sources of the cluster set to a small size may be simultaneously turned on, and the turned-on cluster may be moved in the scan direction.

For example, in the scan mode, the cluster may be selected as columns C1 to C4. In the scan mode, the point light sources of the first column C1 may be simultaneously turned on to emit a laser beam in the form of a line light source. Subsequently, after the point light sources of the second column C2 are simultaneously turned on, the point light sources of the third column C3 may be simultaneously turned on. In this case, in the scan mode, the light sources L constituting the linear light source cluster are turned on to generate a laser beam in the form of a line light source, and the linear light source cluster is turned on to sequentially move the laser beam in the scan direction.

The receiving sensor 106 includes multiple pixels PD arranged in a matrix form made up of a plurality of row lines G1 to G4 and a plurality of column lines D1 to D4. In the flash mode, all pixels of the receiving sensor 106 are activated to convert the received signal into a current every time the light source array LS is turned on. In the scan mode, all pixels of the receiving sensor 106 may be activated in the same manner as the flash mode to convert the laser beam received in the form of a point light source or a line light source into an electrical signal. In another embodiment, in the scan mode, the pixels may be sequentially activated in the scan direction of the point light source or the line light source that is turned on in the light source array LS, and only the activated pixels may convert the received laser beam in the form of the point light source or line light source into an electrical signal.

The pixels of the receiving sensor 106 are sequentially activated in the scan direction of the point light source or the line light source that is turned on in the light source array LS, and only the activated pixels convert the received light into a current.

In the flash mode, all the pixels PD are activated to receive a laser beam in the form of a surface light source and convert the received laser beam into a current. Therefore, in the flash mode, since the object 110 is sensed every time a laser beam in the form of a surface light source is emitted from the light source array LS, the object 110 may be sensed at a high speed.

In the scan mode, only the pixels PD, which are activated by being synchronized with the point light source or the line light source of the light source array LS convert the received light into a current. Since in the scan mode, an object is scanned with a point light source or a line light source, the object 110 at a medium/long distance may be sensed while minimizing the effect of eye safety.

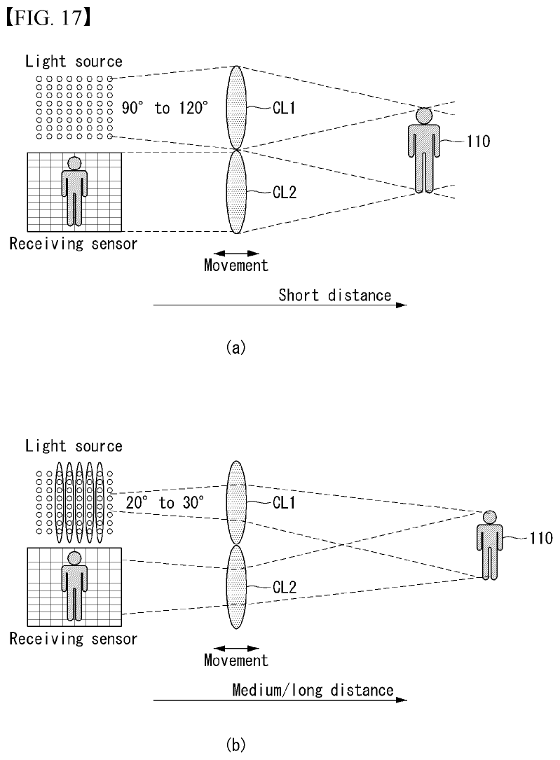

FIG. 17 is a diagram showing the laser beams in the flash mode and in the scan mode.

Referring to FIG. 17(a), when an autonomous vehicle 1610 senses an object 110 that exists at a short distance during traveling, the lidar system may be operated in the flash mode. In the flash mode, laser beams are simultaneously generated from a plurality of point light sources, and thus a laser beam in the form of a surface light source is emitted to the object 110. When the laser beam generated in the flash mode is reflected by the object 110, the reflected laser beam is simultaneously received by the pixels PD of the receiving sensor 106. The laser beam in the form of a surface light source, which is received by the receiving sensor 106, may be processed at a high speed to quickly scan the object 110 at a frequency of several tens of Hz or more.

The laser beam generated in the flash mode may be set to have a large beam width and a large angle of view of approximately 90° to 120° to scan an object at one time without moving the laser beam.

Referring to FIG. 17(b), in the scan mode, the light source array LS may form a preset cluster, and may sequentially generate laser beams through on/off operations for each cluster.

The laser beam in the form of the point light source or the line light source, which is generated in the scan mode, are sequentially moved in a preset scan direction, and is moved for each scan angle by a light scanner SC to scan the object 110.

In the scan mode, since only the light sources included in the cluster of the light source array LS simultaneously generate the laser beam, the object may be sensed within a low angle of view, for example, an angle of view of approximately 20° to 30°. In the scan mode, the cluster of the light source array LS may be set for each column of the plurality of light sources, and the size, shape, and scan speed of the cluster may be changed according to the traveling state of the autonomous vehicle.

Specifically, the size, the number of included light sources, and/or the shape of the cluster may be changed according to the speed and the moving direction of the autonomous vehicle, the position and type of the object, and shape of the road.

For example, the direction in which the cluster is formed may be changed according to the position of the object 110. As the size of the object 110 is larger, the size of the cluster may be increased, and as the size of the object 110 is smaller, the size of the cluster may be decreased.

As the size of the cluster increases, the number of light sources included therein also increases. As the size of the cluster decreases, the number of light sources included therein also decreases. When the laser beam is sequentially generated in the form of the point light source or the line light source in the scan mode in order to sense an object at the medium/long distance, the effect on the safety of eyes of the user may be minimized as compared with the case of using all light sources that emit many beams in an instant.

In addition, in the medium/long distance, the object may be effectively sensed due to the generation of the laser beam through the low angle of view.

In another embodiment of the present disclosure, the distance between the light source and the lens may be individually adjusted in the flash mode and/or the scan mode to change the angle of view.

Specifically, the autonomous vehicle 1610 generates a laser beam through a plurality of point light sources in order to sense the object 110 in the flash mode and/or the scan mode.

In this case, the distances between the plurality of light sources and the lens may be adjusted to adjust the angle of view for each element of the light source.

Alternatively, the distance between each light source and the lens may be adjusted, or the distance between light sources that are grouped in a cluster or a specific unit and the lens may be adjusted.

The distance between the light source and the lens may be adjusted according to the speed of the vehicle, the distance from the object, the state of the object, and/or the size of the object.

For example, when it is difficult to sense the object with a narrow angle of view due to fog or other objects present around the object even if the distance from the object is the same, the distance between the light source and the lens may be adjusted to widen the angle of view even if the object is at the same distance.

Furthermore, a plurality of light sources may be clustered or grouped differently according to the position, distance and size of the object, and/or the speed of the vehicle.

For example, when the object size is large, the clustering or grouping unit of the plurality of light sources may be large, and when the object size is small, the clustering or grouping unit of the plurality of light sources may be small.

Alternatively, the number of light sources clustered or grouped may vary according to the speed of the vehicle.

For example, as the speed of the vehicle increases, multiple light sources may be clustered or grouped to prevent the object 110 from not being sensed due to sequential laser beam generation and scanning.

In addition, the number of light sources clustered or grouped may be changed flexibly according to the speed of the vehicle.

For example, when the speed of the vehicle increases above a certain threshold, the existing light sources that are clustered or grouped may be clustered or grouped into a greater number of light sources again.

The autonomous vehicle 1610 may include a separate module that controls the adjustment of the distance between the light source and the lens.

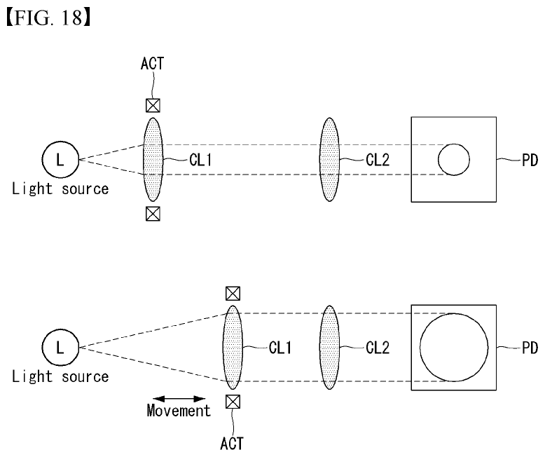

FIG. 18 is a diagram showing an example of a method of adjusting an angle of view.

Referring to FIG. 18, the lidar system according to the embodiment of the present disclosure may further include an angle-of-view adjusting unit.

The angle-of-view adjusting unit includes a lens drive unit for moving the first lens CL1 disposed in front of the light source array LS. The lens drive unit moves the first lens CL1 by using an actuator (ACT) or a step mode. The first lens CL1 may be a collimator lens.

As the distance between the light source L and the first lens CL1 becomes longer, the beam width of the laser beam may be increased, which may lead to the increase in the angle of view. On the other hand, as the distance between the light source L and the first lens CL1 becomes shorter, the beam width of the laser beam may be decreased, which may lead to the decrease in the angle of view.

The lens drive unit may move the lens CL1 to make the distance between the light source array LS and the lens CL1 longer in the flash mode than in the scan mode, and accordingly the beam width and angle of view of the laser beam in the flash mode may be increased.

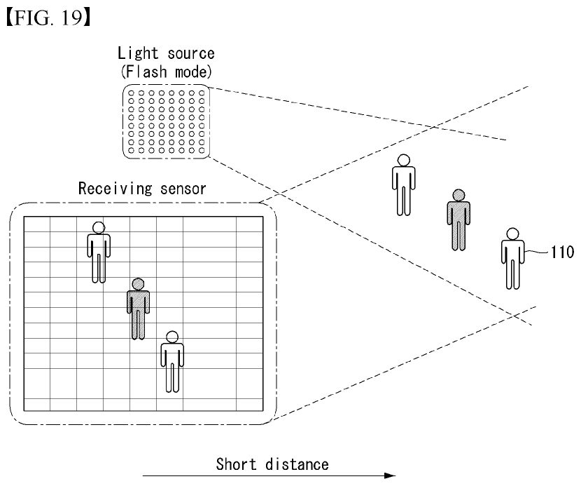

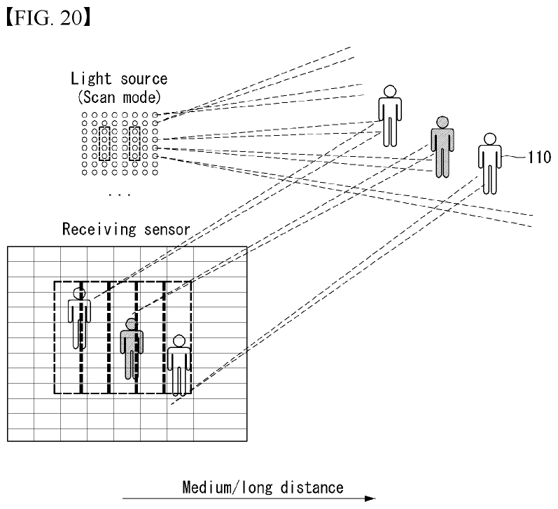

FIG. 19 is a diagram showing a flash mode according to an embodiment of the present disclosure. FIG. 20 is a diagram showing a scan mode according to an embodiment of the present disclosure.

Referring to FIGS. 19 and 20, in order to sense an object at a short distance, an object may be recognized by causing all the light sources to generate the laser beams in the flash mode and receiving beams reflected at one time.

When the speed increases above a certain speed after the vehicle 10 starts to travel, since the moving distance increases with the speed, the autonomous vehicle is to recognize an object located at a distant distance.

For the autonomous vehicle, the lidar system may operate in the medium/long range scan mode when the speed of the vehicle increases above a certain speed. In the medium/long range scan mode, the light source array LS may generate a laser beam in the form of a surface light source.

In the scan mode, since the light source array LS generates a laser beam in the form of the point light source or the linear light source, eye safety constraints are relatively low, which may be effective for medium/long distance sensing.

Since the object at the medium/long distance may be sensed with a small angle of view, the laser beam may be generated by driving only some point light sources L, rather than driving all the point light sources L of the light source array LS.

In the scan mode, since the laser beam is sequentially moved in the scan direction, one frame signal is obtained after the laser beam is moved several times to scan the object. For this reason, the scan mode is used for the medium/long distance even if the scan speed of the object is slow in the scan mode. In this case, considering the distance that the vehicle recognizes the object and brakes, a scan speed above a certain speed is to be maintained (for example, at least 20 Hz).

In the medium/long range scan mode, the type, position, the number of included light sources of the cluster may be changed according to the speed and the moving direction of the autonomous vehicle, and the type, size, and position of the object.

For example, in order to recognize a small object, the size and the number of included light sources of the cluster may be decreased, and in order to recognize a large object, the size and the number of included light sources of the cluster may be increased.

That is, when the size of the cluster is smaller than the size of the object, apart of the object may be missing and recognized, or the object may be recognized through a plurality of scans. Therefore, the size of the cluster needs to be adjusted according to the size of the object. Therefore, when the size of the object is larger than the size of the cluster, the size of the cluster may be changed according to the size of the object.

For example, in order to recognize the small object, the size of the cluster does not need to be large. In this case, the size of the cluster may be decreased according to the size of the object, and the number of light sources included in the cluster may be decreased.

In addition, when the size of the object is large, the size of the cluster may increase according to the size of the object, and the number of light sources included in the cluster may also increase. The shape and form of the clusters may vary according to traveling information such as the speed and the moving direction of the vehicle.

The scan mode may be usefully applied to autonomous driving or auto cruise control (ACC) on a highway, and energy consumption may be reduced since all light sources do not operate.

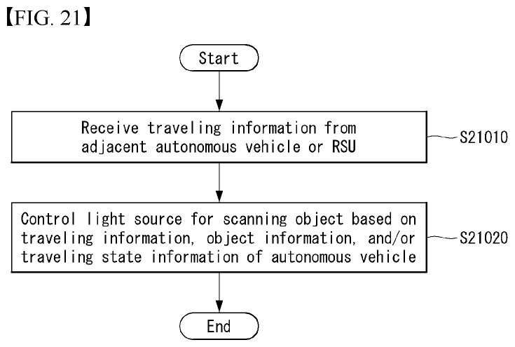

FIG. 21 is a flowchart showing an example of a method for controlling a light source according to an embodiment of the present disclosure.

Referring to FIG. 21, an autonomous vehicle may control a light source to sense an object through the flash mode and the scan mode.

Specifically, the autonomous vehicle may receive traveling information from an adjacent autonomous vehicle and/or an RSU in order to sense an object through the flash mode and the scan mode (S21010).

The traveling information is information that may affect the sensing of the object, and may include congestion information of vehicles, state information of a road, weather information, and/or map information.

The autonomous vehicle may control a light source for scanning the object based on the acquired traveling information, object information, and/or traveling state information of the autonomous vehicle (S21020).

The object information may include at least one of the position of the object, the size of the object, or the state of the object as to whether the object is moved, and the traveling state information may include at least one of a traveling mode (for example, parking mode), a traveling speed, or destination information of the vehicle.

The autonomous vehicle may control a distance between a plurality of light sources and the lens, a size of a cluster, the number of light sources included in the cluster, and/or turn-on/off of the light source based on traveling information, object information, and/or the traveling state information, which makes it possible to sense the object in the flash mode or scan mode.

For example, as described above, the angle of view may be increased or decreased by increasing or decreasing the distance between the plurality of light sources and the lens.

Alternatively, the autonomous vehicle may increase or decrease the size of the cluster and/or the number of light sources included in the cluster based on the size of the object, according to the object information, the traveling information, and/or the traveling state information.

For example, when the size of an object is larger than the size of a cluster, a part of the object may not be sensed through one cluster. Therefore, the size of the cluster and the number of light sources included in the cluster may be increased so that the object may be sensed through one cluster.

Alternatively, the size of the cluster may be increased when the speed of the vehicle is increased according to the traveling state information and so the object is to be quickly scanned, or when the object is difficult to be sensed in the fog or in the rain according to the weather information of the traveling information.

That is, when the speed of the vehicle increases, the object may not be sensed due to the sequential turning-on of the cluster, or the object may be difficult to be sensed in the fog or in the rain.

In this case, the object may be efficiently sensed by setting the size of the cluster to be larger than the general case and increasing the number of light sources included therein.

Alternatively, some of the light sources constituting the cluster or a part of the entire cluster may be turned on or off according to the object information.

Specifically, some of the light sources constituting the cluster or a part of the entire cluster may be turned off depending on whether the position of the object according to the object information is located on the left side or right side, or up or down.

For example, when the object is located on the left side of the autonomous vehicle, scanning through the clusters located on the right side of the entire clusters may not be necessary for sensing the object. In this case, by turning off clusters located on the right side, it is possible to reduce power consumption for sensing an object.

Alternatively, when the size of the object is smaller than the size of the cluster and located on the left side of the autonomous vehicle, it is not necessary to turn on all the light sources included in the cluster. Therefore, in this case, the light sources included in the right side of the cluster may be turned off.

As another example, when the object is located above the autonomous vehicle according to the object information, the shape of the cluster may be changed according to the position and shape of the object, and when the object is scanned in the flash mode and the scan mode according to the object position, the upper clusters of the entire clusters may be controlled to generate the laser beam first.

As yet another example, when the object is in close contact with at least one other object based on the object information, it may be difficult to clearly recognize the size of the object. In this case, the size of the cluster and the number of light sources included in the cluster may be adjusted by considering not only the size of the object but also the size of the at least one other object.

In addition, since the speed of the vehicle is reduced on the heavy traffic road according to the traveling information of the vehicle, the scan speed may be reduced, or the size of the cluster or the number of light sources turned on may be reduced.

Thereafter, the autonomous vehicle may control the light sources to sense an object through the flash mode and the scan mode.

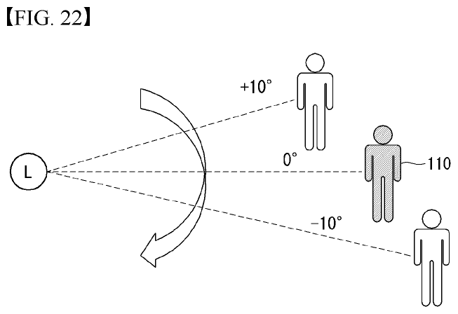

FIG. 22 is a diagram showing an example in which a laser beam is moved along a scan angle in the scan mode. FIG. 22 is a diagram showing pixels of a receiving sensor activated for each scan angle shown in FIG. 21.

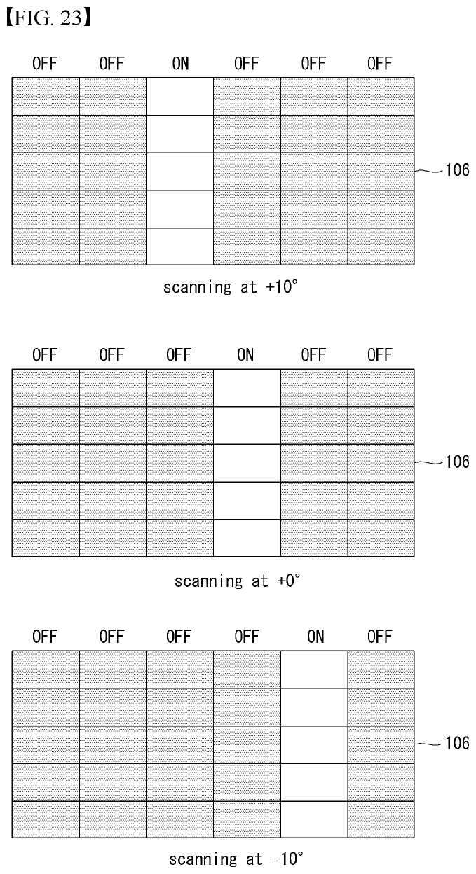

Referring to FIGS. 22 and 23, the sensor processor 120 synchronizes the scanning of the light scanner SC with the pixels of the receiving sensor 102 to selectively activate the pixels for each scan angle of the laser beam, such that in the laser beam, only the light of the main lobe except the side lobe may be converted into an electrical signal. For example, when the laser beam is emitted forward at the front angle (0°), only 0° pixels where the laser beam is received at the front angle (0°) may be activated (ON), as shown in FIG. 22. In this case, only light of the main lobe of the laser beam received at the front angle (0°) is converted into a current. Pixels other than 0° pixels are deactivated (OFF), and thus the light of the side lobe is not converted to the electrical signal. Therefore, the influence due to the light of the side lobe in the received signal may be reduced.

For example, when the laser beam is emitted forward at +10° by the light scanner SC, only +10° pixels where the laser beam reflected from +10° is received may be activated (ON), as shown in FIG. 21. In this case, only the light of the main lobe of the laser beam received at +10° is converted to a current. Pixels other than +10° pixels are deactivated (OFF) and thus the light of the side lobe is not converted to the electrical signal.

When the laser beam is emitted forward at −10° by the light scanner SC, only −10° pixels where the laser beam reflected from −10° is received may be activated (ON), as shown in FIG. 21. In this case, only the light of the main lobe 71 of the laser beam received at −10° is converted to a current. Pixels other than −10° pixels are deactivated (OFF) and thus the light of the side lobe is not converted to the electrical signal.

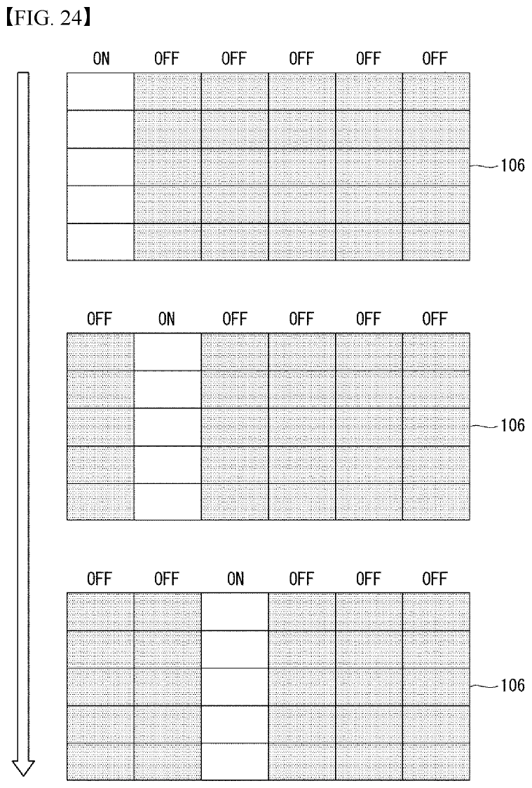

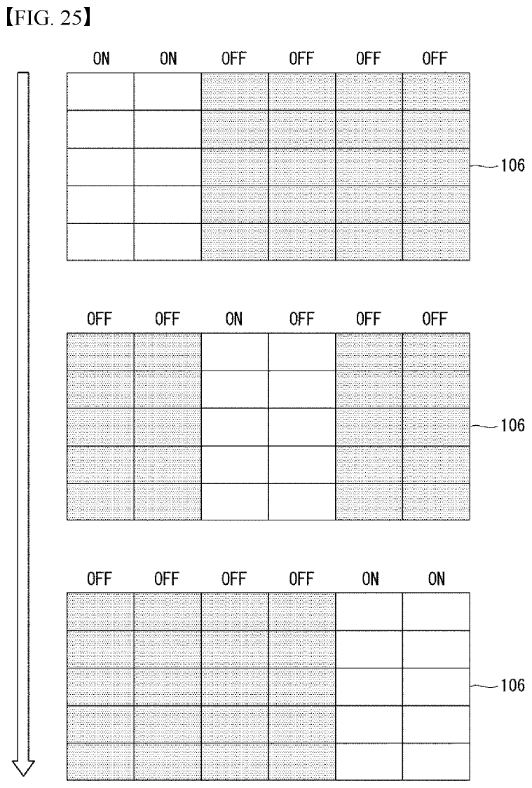

FIGS. 24 and 25 are diagrams showing examples of variable sizes of an optical sensor cluster activated according to a sensing distance.

Referring to FIGS. 24 and 25, the sensor processor 120 may increase the size of the cluster of the receiving sensor 106 as the distance increases in the scan mode. Here, the cluster of the receiving sensor 106 includes pixels DP that are simultaneously activated. For example, the cluster of the receiving sensor may be one column as shown in FIG. 22 at a medium distance, and two columns as shown in FIG. 23 at a long distance.

The sensor processor 120 activates the pixels in units of columns for each scan angle in the receiving sensor 106, but may make the number of columns activated for each scan angle in medium distance sensing lower than the number of columns activated in long distance sensing. For example, as shown in FIG. 23, the sensor processor 120 may activate pixels by one column for each scan angle in the receiving sensor 106 when the object 110 at a medium distance is sensed. The sensor processor 120 may activate pixels by two columns for each scan angle in the receiving sensor 106 in the long distance sensing, as shown in FIG. 24.

The sensor processor 120 may increase the number of columns activated for each scan angle as the sensing distance increases. The cluster (or column) activated at the receiving sensor 106 may be shifted along the scan angle of the laser beam as shown in FIGS. 24 and 25.

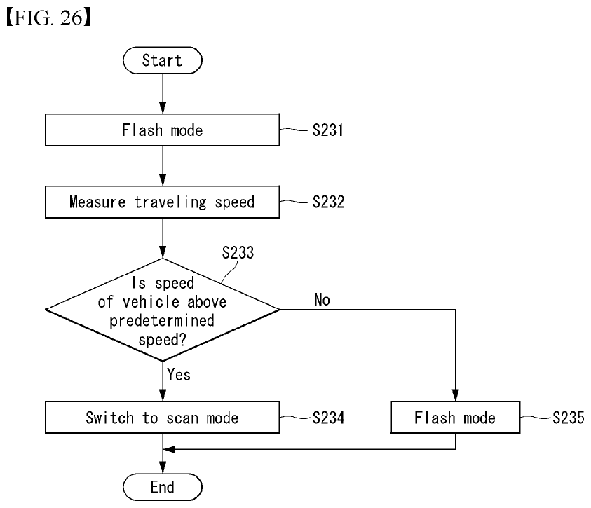

FIG. 26 is a diagram showing an example of a method of controlling a flash mode and a scan mode selected according to a speed of the vehicle.

Referring to FIG. 26, when the vehicle 10 starts traveling, the autonomous driving device 260 may control the lidar system to the flash mode to sense the object 110 (S231). In the flash mode, the light source array LS emits a laser beam in the form of the surface light source, and the receiving sensor 106 may receive light of the laser beam through all of the activated pixels to convert the received light into an electrical signal. Since the speed of the vehicle is low immediately after the vehicle 10 starts traveling, it is advantageous for safe traveling to quickly sense an object at the short distance in a flash mode.

The speed of the vehicle 10 may be measured in real time through the ECU in the vehicle 10 (S232). The autonomous driving device 260 may receive a feedback of controller area network (CAN) data and measure the speed of the vehicle in real time, and measure the speed of another vehicle 10 through the V2X data received from the network through V2X communication.

When the speed of the vehicle 10 is equal to lower than a predetermined speed, for example, 50 km/h, the object 110 at the short distance may be sensed while maintaining the flash mode (S233 and S235).

The autonomous driving device 260 may switch the lidar system to the scan mode when the speed of the vehicle 10 increases above a predetermined speed (S233 and S234). In the flash mode, the light source array LS emits a laser beam in the form of the point light source or the line light source. In the scan mode, the receiving sensor 106 may receive light through all pixels or convert light, which is received through some pixels activated in synchronization with the laser beam, into an electrical signal.

Various embodiments of the lidar system of the present disclosure will be described below.

### Embodiment 1

The lidar system includes a light source array in which a plurality of point light sources is simultaneously turned on to generate a laser beam in a form of a surface light source in a flash mode, and positions of the point light sources that are simultaneously turned on are sequentially shifted to generate a laser beam in a form of a point light source or line light source in a scan mode, a light scanner moving the laser beam in the form of the point light source or the line light source generated in the scan mode, and a receiving sensor receiving the laser beam and converting the received laser beam into an electrical signal through activated pixels.

### Embodiment 2

The number of point light sources simultaneously turned on in the scan mode may be set less than the number of point light sources simultaneously turned on in the flash mode.

### Embodiment 3

A beam width of the laser beam generated in the flash mode may be set greater than a beam width of the laser beam simultaneously generated in the scan mode.

### Embodiment 4

The light source array may be turned on in the flash mode when an object at a preset short distance is sensed, and the light source array may be turned on in the scan mode when an object at a medium/long distance longer than the short distance is sensed.

### Embodiment 5

The lidar system may further include an angle-of-view adjusting unit widening an angle of view of the laser beam in the flash mode and narrowing an angle of view of the laser beam in the scan mode. The angle-of-view adjusting unit may include a lens drive unit moving a lens disposed in front of the light source array such that a distance between the light source array and the lens is made longer in the flash mode than in the scan mode.

### Embodiment 6

The lidar system may further include a signal processor including a preamplifier for amplifying an output signal of the receiving sensor, an analog-digital converter for converting an output signal of the preamplifier to a digital signal, and a gain processor for varying a gain of the preamplifier.

The gain processor may adjust the gain of the preamplifier according to a sensing distance.

### Embodiment 7

The gain processor may make the gain of the preamplifier smaller in the flash mode than in the scan mode.

### Embodiment 8

The lidar system may further include a sensor processor synchronizing the light scanner and the receiving sensor with each other. The sensor processor may select pixels activated by being synchronized with the laser beam moved by the light scanner in the scan mode. The pixels of the receiving sensor may be sequentially activated to be synchronized with the movement of the laser beam under control of the sensor processor in the scan mode.

### Embodiment 9

The number of pixels that are simultaneously activated may increase as a sensing distance in the scan mode becomes larger.

### Embodiment 10

The flash mode or the scan mode may be selected according to a speed of a vehicle on which the lidar system is mounted.

### Embodiment 11

The light source array may be turned on in the flash mode when the speed of the vehicle is equal to or less than a predetermined speed, and the light source array may be turned on in the scan mode when the speed of the vehicle is faster than the predetermined speed.

### Embodiment 12

The light source array may be turned on in the flash mode when a speed of a vehicle on which the lidar system is mounted is equal to or less than a predetermined speed, and an object at a short distance is sensed. The light source array may be turned on in the scan mode when the speed of the vehicle on which the lidar system is mounted is faster than the predetermined speed, and an object at a medium/long distance is sensed.

Various embodiments of the method of controlling the lidar system will be described below.

### Embodiment 1

The method includes setting a flash mode in which a plurality of point light sources arranged in a light source array is simultaneously turned on to generate a laser beam in a form of a surface light source in the light source array, setting a scan mode in which positions of the point light sources that are simultaneously turned on in the light source array are sequentially shifted to generate a laser beam in a form of a point light source or line light source in the light source array, moving the laser beam in the form of the point light source or the line light source generated in the scan mode by using a light scanner disposed in front of the light source array, and converting the laser beam in the flash mode into an electrical signal through activated pixels of a receiving sensor receiving the laser beam.

### Embodiment 2

The method may further include controlling the light source array to the flash mode when an object at a preset short distance is sensed, and controlling the light source array to the scan mode when an object at a medium/long distance longer than the short distance is sensed.

### Embodiment 3

The method may further include widening an angle of view of the laser beam in the flash mode and narrowing an angle of view of the laser beam in the scan mode.

### Embodiment 4

The method may further include making again of a preamplifier for amplifying an output signal of the receiving sensor smaller in the flash mode than in the scan mode.

### Embodiment 5

The method may further include selecting pixels activated by being synchronized with the laser beam moved by the light scanner in the scan mode, and sequentially shifting the positions of the activated pixels to be synchronized with the movement of the laser beam under control of the sensor processor in the scan mode.

### Embodiment 6

The method may further include controlling the light source array to the flash mode when the speed of the vehicle is equal to or less than a predetermined speed, and controlling the light source array to the scan mode when an object at a medium/long distance longer than the short distance is sensed.

Various embodiments of the autonomous driving system of the present disclosure will be described below.

### Embodiment 1

The autonomous driving system includes an autonomous driving device receiving sensor data from the lidar system and reflecting information on the object in controlling movement of the vehicle.

### Embodiment 2

The number of point light sources simultaneously turned on in the scan mode may be set less than the number of point light sources simultaneously turned on in the flash mode.

### Embodiment 3

A beam width of the laser beam generated in the flash mode may be set greater than a beam width of the laser beam simultaneously generated in the scan mode.

### Embodiment 4

The light source array may be turned on in the flash mode when an object at a preset short distance is sensed, and the light source array may be turned on in the scan mode when an object at a medium/long distance longer than the short distance is sensed.

### Embodiment 5

The lidar system may further include an angle-of-view adjusting unit widening an angle of view of the laser beam in the flash mode and narrowing an angle of view of the laser beam in the scan mode. The angle-of-view adjusting unit may include a lens drive unit moving a lens disposed in front of the light source array such that a distance between the light source array and the lens is made longer in the flash mode than in the scan mode.

### Embodiment 6

The lidar system may further include a signal processor including a preamplifier for amplifying an output signal of the receiving sensor, an analog to digital converter for converting an output signal of the preamplifier to a digital signal, and a gain processor for varying a gain of the preamplifier. The gain processor may adjust the gain of the preamplifier according to a sensing distance.

### Embodiment 7

The gain processor may make the gain of the preamplifier smaller in the flash mode than in the scan mode.

### Embodiment 8

The lidar system may further include a sensor processor synchronizing the light scanner and the receiving sensor with each other. The sensor processor may select pixels activated by being synchronized with the laser beam moved by the light scanner in the scan mode. The pixels of the receiving sensor may be sequentially activated to be synchronized with the movement of the laser beam under control of the sensor processor in the scan mode.

### Embodiment 9

The number of pixels that are simultaneously activated may increase as a sensing distance in the scan mode becomes larger.

### Embodiment 10

The flash mode or the scan mode may be selected according to a speed of a vehicle on which the lidar system is mounted.

### Embodiment 11

The light source array may be turned on in the flash mode when the speed of the vehicle is equal to or less than a predetermined speed, and the light source array may be turned on in the scan mode when the speed of the vehicle is faster than the predetermined speed.

### Embodiment 12

The light source array may be turned on in the flash mode when a speed of a vehicle on which the lidar system is mounted is equal to or less than a predetermined speed, and an object at a short distance is sensed, and the light source array may be turned on in the scan mode when the speed of the vehicle on which the lidar system is mounted is faster than the predetermined speed, and an object at a medium/long distance is sensed.

The present disclosure described above may be embodied as computer readable codes on a medium on which a program is recorded. A computer-readable medium includes all kinds of recording devices in which data that may be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Examples of the computer-readable medium also includes an implementation in the form of a carrier wave (for example, transmission over the Internet). Accordingly, the detailed description should not be construed as being limitative, but should be construed as being illustrative from all aspects. The scope of the present disclosure should be determined by reasonable analysis of the attached claims, and all changes within the equivalent range of the present disclosure are included in the scope of the present disclosure.

In the autonomous driving system according to an embodiment of the present disclosure, the effects of the method and apparatus for the vehicle to scan an object are as follows.

According to the present disclosure, by scanning an object in a flash mode or a scan mode using a laser beam generated from a plurality of light sources, the object may be efficiently scanned to improve the problem of limitation in the sensing distance and angle of view.

In addition, the present disclosure may sense the object at a high scanning speed without adversely affecting the human retina by varying the number of light sources that are turned on to generate a beam according to the sensing distance.

Effects of the present disclosure are not limited to the above-described effects, and other technical effects not described above may be evidently understood by those skilled in the art to which the present disclosure pertains from the following description.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lidar system comprising:
a light source array in which a plurality of point light sources is simultaneously turned on to generate a laser beam in a form of a surface light source in a flash mode, and positions of the point light sources that are simultaneously turned on are sequentially shifted to generate a laser beam in a form of a point light source or line light source in a scan mode;
a light scanner moving the laser beam in the form of the point light source or the line light source generated in the scan mode; and
a receiving sensor receiving the laser beam and converting the received laser beam into an electrical signal through activated pixels.

2. The lidar system of claim 1,
wherein the number of point light sources that are simultaneously turned on in the scan mode is less than the number of point light sources that are simultaneously turned on in the flash mode.

3. The lidar system of claim 2,
wherein a beam width of the laser beam generated in the flash mode is greater than a beam width of the laser beam generated in the scan mode.

4. The lidar system of claim 1,
wherein the light source array is turned on in the flash mode when an object at a preset short distance is sensed, and
the light source array is turned on in the scan mode when an object at a medium/long distance longer than the short distance is sensed.

5. The lidar system of claim 2, further comprising:
an angle-of-view adjusting unit widening an angle of view of the laser beam in the flash mode and narrowing an angle of view of the laser beam in the scan mode,
wherein the angle-of-view adjusting unit includes a lens drive unit moving a lens disposed in front of the light source array such that a distance between the light source array and the lens is made longer in the flash mode than in the scan mode.

6. The lidar system of claim 2, further comprising:
a signal processor including a preamplifier for amplifying an output signal of the receiving sensor, an analog to digital converter for converting an output signal of the preamplifier to a digital signal, and a gain processor for varying a gain of the preamplifier,
wherein the gain processor adjusts the gain of the preamplifier according to a sensing distance.

7. The lidar system of claim 6,
wherein the gain processor makes the gain of the preamplifier smaller in the flash mode than in the scan mode.

8. The lidar system of claim 1, further comprising:
a sensor processor synchronizing the light scanner and the receiving sensor with each other,
wherein the sensor processor selects pixels activated by being synchronized with the laser beam moved by the light scanner in the scan mode, and
the pixels of the receiving sensor are sequentially activated to be synchronized with the movement of the laser beam under control of the sensor processor in the scan mode.

9. The lidar system of claim 8,
wherein the number of pixels that are simultaneously activated increases as a sensing distance in the scan mode becomes larger.

10. The lidar system of claim 1,
wherein the flash mode or the scan mode is selected according to a speed of a vehicle on which the lidar system is mounted.

11. The lidar system of claim 10,
wherein the light source array is turned on in the flash mode when the speed of the vehicle is equal to or less than a predetermined speed, and
the light source array is turned on in the scan mode when the speed of the vehicle is faster than the predetermined speed.

12. The lidar system of claim 11,
wherein the light source array is turned on in the flash mode when a speed of a vehicle on which the lidar system is mounted is equal to or less than a predetermined speed, and an object at a short distance is sensed, and
the light source array is turned on in the scan mode when the speed of the vehicle on which the lidar system is mounted is faster than the predetermined speed,
and an object at a medium/long distance is sensed.

13. A method of controlling a lidar system, the method comprising:
setting a flash mode in which a plurality of point light sources arranged in a light source array is simultaneously turned on to generate a laser beam in a form of a surface light source in the light source array;
setting a scan mode in which positions of the point light sources that are simultaneously turned on in the light source array are sequentially shifted to generate a laser beam in a form of a point light source or line light source in the light source array;
moving the laser beam in the form of the point light source or the line light source generated in the scan mode by using a light scanner disposed in front of the light source array; and
converting the laser beam in the flash mode into an electrical signal through activated pixels of a receiving sensor receiving the laser beam.

14. The method of claim 13, further comprising:
controlling the light source array to the flash mode when an object at a preset short distance is sensed; and
controlling the light source array to the scan mode when an object at a medium/long distance longer than the short distance is sensed.

15. The method of claim 14, further comprising:
widening an angle of view of the laser beam in the flash mode and narrowing an angle of view of the laser beam in the scan mode.

16. The method of claim 13, further comprising:
making a gain of a preamplifier for amplifying an output signal of the receiving sensor smaller in the flash mode than in the scan mode.

17. The method of claim 13, further comprising:
selecting pixels activated by being synchronized with the laser beam moved by the light scanner in the scan mode; and
sequentially shifting the positions of the activated pixels to be synchronized with the movement of the laser beam under control of the sensor processor in the scan mode.

18. The method of claim 13, further comprising:
controlling the light source array to the flash mode when the speed of the vehicle is equal to or less than a predetermined speed; and
controlling the light source array to the scan mode when an object at a medium/long distance longer than the short distance is sensed.

19. An autonomous driving system comprising:
a lidar system sensing an object outside a vehicle by emitting a laser beam outside the vehicle; and
an autonomous driving device receiving sensor data from the lidar system and reflecting information on the object in controlling movement of the vehicle,
wherein the lidar system comprises:
a light source array in which a plurality of point light sources is simultaneously turned on to generate a laser beam in a form of a surface light source in a flash mode, and positions of the point light sources that are simultaneously turned on are sequentially shifted to generate a laser beam in a form of a point light source or line light source in a scan mode;
a light scanner moving the laser beam in the form of the point light source or the line light source generated in the scan mode; and
a receiving sensor receiving the laser beam and converting the received laser beam into an electrical signal through activated pixels.

20. The autonomous driving system of claim 19,
wherein the number of point light sources simultaneously turned on in the scan mode is less than the number of point light sources simultaneously turned on in the flash mode.
